(19) United States
(12) Patent Application Publication
(10) Pub. No.: US 2017/0279656 A1
(43) Pub. Date: Sep. 28, 2017

(54) METHODS AND SYSTEMS OF PROVIDING BROWSER CROSS-PAGE COMMUNICATION USING PORTS

(71) Applicant: Google Inc., Mountain View, CA (US)

(72) Inventor: Eduardo Alberto Vela Nava, Mountain View, CA (US)

(73) Assignee: Google Inc., Mountain View, CA (US)

(21) Appl. No.: 14/140,962

(22) Filed: Dec. 26, 2013

(51) Int. Cl. H04L 12/24

(52) U.S. Cl. CPC H04L 41/026

(57) ABSTRACT

A method of establishing a communication channel between browser windows may include generating, by a client network comprising a plurality of browser windows that each serve as hosts for one or more peers, a discovery request that comprises a name of a requested service and instantiation information, sending the discovery request to a plurality of the peers, wherein each peer is a script unit, and receiving a response from one or more of the plurality of the peers. Each response may include an indication of a port associated with the peer that will serve as a reference to the requested service. The method may include accepting, by the client network, one of the received responses.

### BACKGROUND

The advent of rich Internet applications that transfer a substantial amount of application logic to clients has resulted in the need for web pages from different origins to communicate with one another. To accomplish this communication, the inventors have discovered that a cross-browser secure transport mechanism is desirable.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of establishing a communication channel between browser windows may include generating, by a client network comprising a plurality of browser windows that each serve as hosts for one or more peers, a discovery request that comprises a name of a requested service and instantiation information, sending the discovery request to a plurality of the peers, wherein each peer is a script unit, and receiving a response from one or more of the plurality of the peers. Each response may include an indication of a port associated with the peer that will serve as a reference to the requested service. The method may include accepting, by the client network, one of the received responses.

In an embodiment, a system for establishing a communication channel between browser windows may include a computing device configured to operate a plurality of browser windows, that each serves as a host for one or more peers, and a computer-readable storage medium in communication with the computing device. The computer-readable storage medium may include one or more programming instructions that, when executed, cause the computing device to generate a discovery request that comprises a name of a requested service and instantiation information, send the discovery request to a plurality of the peers, receive a response from one or more of the plurality of the peers, and accept one of the received responses. Each response may include an indication of a port associated with the peer that will serve as a reference to the requested service, and each peer may be a script unit.

### BRIEF DESCRIPTION OF THE DRAWINGS

FIG. 1 illustrates example network that includes four browser windows of a client according to an embodiment.

FIG. 2 illustrates an example method of locating a service provider according to an embodiment.

FIG. 3 illustrates an example diagram of sending and receiving discovery messages and responses among a network of peers according to an embodiment.

FIG. 4 illustrates a block diagram of example hardware that may be used to contain or implement program instructions according to an embodiment.

### DETAILED DESCRIPTION

The following terms shall have, for purposes of this application, the respective meanings set forth below:

A “computing device” refers to a device that includes a processor and non-transitory, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like. When used in the claims, reference to “a computing device” may include a single device, or it may refer to several devices that together perform the claimed steps.

A “peer” refers to a single script unit that is associated with one or more web-based services. When a user of a browser selects a command that actuates a peer, the peer causes its associated web-based service to launch or otherwise activate.

A “web-based service” or “service” refers to a service provided via the Internet or other network. Example services may include, without limitation, email, social networking, electronic banking, e-commerce services and/or the like.

A “widget” refers to software that is embedded, installed and/or executed on a web site. A widget may be associated with a particular service, and may provide a user with certain functionality. A widget may be implemented as an icon, a menu, a button, a selection box, a scroll bar and/or the like. Example widgets may include, without limitation, social media buttons, weather applications, calendar applications and/or the like.

It may be beneficial for independent pieces or segments of code such as, for example, those running in different browser contexts, to communicate directly with one another. One way in which this communication may occur may be through channel messaging. Channel messaging may implement a two-way communication channel between a pair of code segments, with each channel having a port at each end. A message sent in one port may be delivered to the other port.

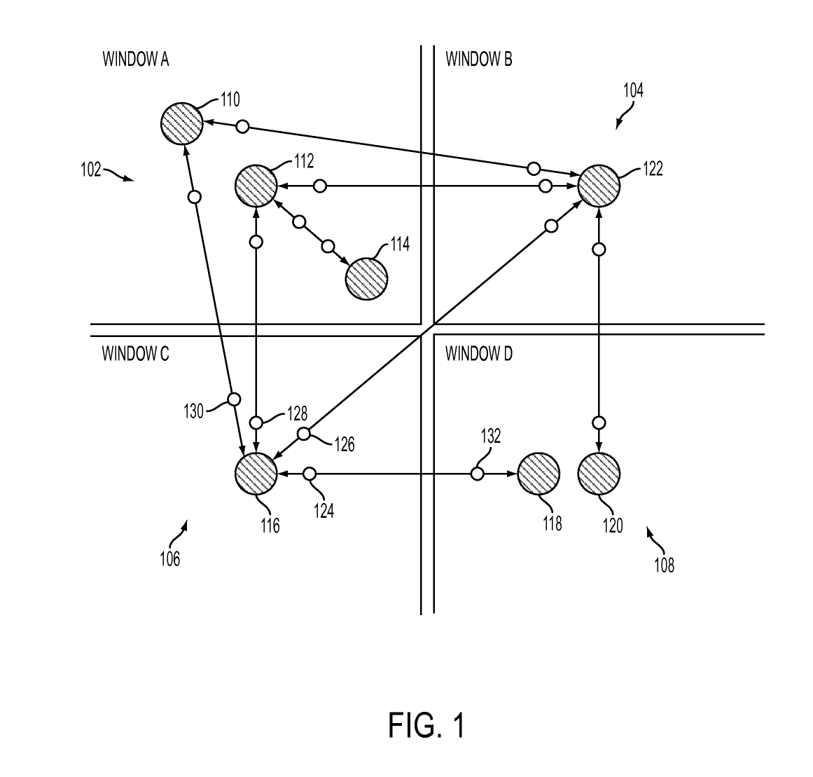

FIG. 1 illustrates an example network that includes four browser windows of a client according to an embodiment. A browser window may be a software application that retrieves, accesses and/or displays information from the Internet or other network.

As illustrated by FIG. 1, each browser window 102, 104, 106, 108 may act as a host for one or more peers 110, 112, 114, 116, 118, 120, 122. A peer may have one or more ports connected to it. For example, as illustrated by FIG. 1, peer 116 is associated with ports 124, 126, 128 and 130, and peer 118 is associated with port 132. In an embodiment, a port may provide an endpoint for a communication channel with one or more other ports. The port or ports to which a port enables communication may be associated with one or more peers in the same or another browser window. For example, port 124 which is associated with peer 116 in browser window 106 may establish a channel to communicate with port 132 which is associated with peer 118 in browser window 108.

In an embodiment, a port may establish a suitable communication channel with one or more other ports such as, for example, a MessageChannel object. A MessageChannel object may provide two-way asynchronous messaging through ports that enables intra-window and inter-window communication.

As an example, a browser page may have an indication, such as a button, associated with a social networking service and an indication, such as another button, associated with an electronic payment service. Each service may have a corresponding peer. If the button associated with the social networking service wants to interact with the button associated with the electronic payment service, such as, for example, to communicate information between the two services, then the social networking button may connect its peer to the electronic payment service's peer.

In an embodiment, a network may require a certain service. A peer may provide one or more services to one or more other peers in communication with the peer. For example, referring to FIG. 1, peer 116 may provide a service to peers 110, 112, 114 and 118.

In an embodiment, peers may register with one another before they are able to communicate. For example, a first peer may send a message to a second peer, such as, for example, a child window peer or a worker peer. The message may include an initialization instruction or indication such as, for example “INIT”. In an embodiment, the message may include an indication of a port that can be used for further communication.

In an embodiment, a service may have an associated access control list (ACL). An ACL may specify for one or more ports, one or more services a port can provide, to which other ports it can provide the services and to which other ports the port can connect to provide one or more services.

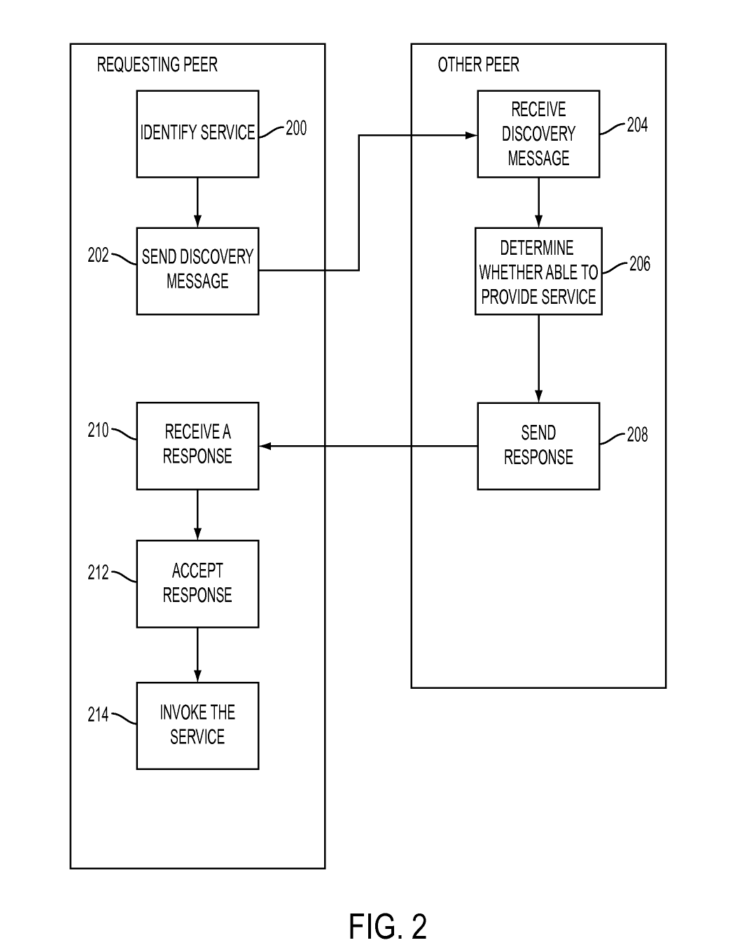

In an embodiment, a client may need to locate a service provider in its network. FIG. 2 illustrates an example method of locating a service provider according to an embodiment. As illustrated by FIG. 2, a peer may identify 200 a service to be requested. For example, a chat application client may want to locate a dialog service.

The peer may send 202 a discovery message to one or more other peers in its network. In an embodiment, a discovery message may include information about the requested service such as, for example, the name of the service. The name of the service may be provided in the format of a uniform resource identifier (URI).

In an embodiment, a discovery message may include instantiation information. Instantiation information may include information needed to instantiate the requested service. This information may include, without limitation, a scope of a service, an action to be performed by a service, a function associated with a service and/or the like. For example, the following pseudo code instruction may be used to find a service that authorizes a scope for an email application—port.findService(SERVICE, {scope: “https://www.service”}, function(res, port) { // ...}).

As another example, the following pseudo code instruction may be used to locate a PGP service that can decrypt a message's key—port.findService(PGP_SERVICE, {action: “DECRYPT”, message: “----BEGIN PGP MESSAGE---[...]----END PGP MESSAGE----”}, function(res, port) { // ...}). Additional and/or alternate instructions may be used within the scope of this disclosure.

In an embodiment, a peer may use an ACL to determine to which other peers to send a discovery message. For example, an ACL may identify one or more peers that are allowed to provide a requested service. The peer may identify these peers, and only send a discovery message to these peers.

In an embodiment, one or more other peers may receive 204 the discovery message. The peer may determine 206 whether it is able to provide the requested service. For example, a peer may use the service name and/or the instantiation information in the discovery message to determine 206 whether it is able to provide the requested service. In an embodiment, a peer may access an associated ACL to determine 206 whether it is able to provide the requested service. For instance, referring to the above example, a peer may receive a discovery request for a dialog service. The peer may access an ACL to determine 206 whether it is able to provide the service and fulfill the request.

In an embodiment, if the peer determines that it is able to provide the service, the peer may send 208 the requesting peer a response. The response may include an indication that the peer is able to provide the service. In an embodiment, the response may include an indication of the port that the requesting peer can use to access the instance of the requested service. In an embodiment, if the peer determines that it is not able to provide the services, the peer may not send a response.

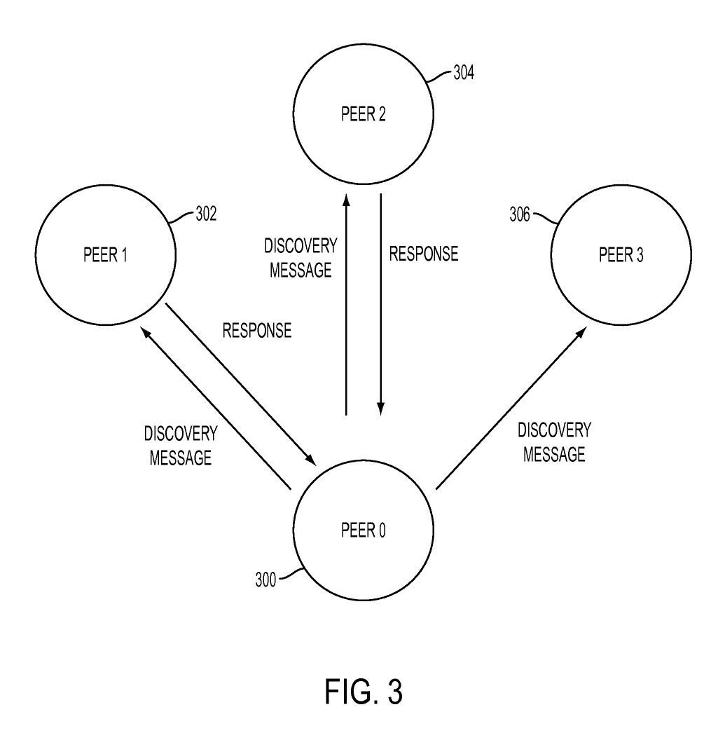

FIG. 3 illustrates an example diagram of sending and receiving discovery messages and responses among a network of peers according to an embodiment. As illustrated by FIG. 3, Peer 0 300 may send a discovery message to each of Peer 1 302, Peer 2 304 and Peer 3 306. If the peers are able to provide the service, each of Peer 1 302, Peer 2 304 and Peer 3 306 may respond to Peer 0 300 with a response.

Referring back to FIG. 2, the requesting peer may receive 210 the response. If the requesting peer receives 210 a response from more than one of the other peers, the requesting peer may decide which response to accept. In an embodiment, the requesting peer may accept 212 a response, and may invoke 214 the service via the peer associated with the accepted response.

In an embodiment, a remote procedure call (RPC) protocol may be used to provide inter-process or inter-peer communication between two or more peers. According to the RPC protocol, each call to a service instance may include an indication of a method and one or more arguments. An indication of a method may include information about the method that is being called in the service. In an embodiment, the one or more arguments may be arguments that are to be sent to the service.

In an embodiment, certain browsers may not support channel messaging as described above. In these situations, a transport layer polyfill may be used to provide security protection on top of the network layer. A network layer may refer to the network layer of the Open Systems Interconnection (OSI) model according to an embodiment.

In an embodiment, a polyfill may be used to create new channels on demand and send responses via the channels. Once a port is exported, messages may be reliably sent to their new destination, and a previous owner may not be able to read the messages.

A message may be sent through a network layer in the form of a public message. The message may be associated with one or more fields. An example field may be a transport mode field, which may indicate when and to what extend a window can be able to spoof of read messages that belong to another window. Example values for a transport mode field may be Insecure, Integrity, Privacy or Integrity+Privacy. In an embodiment, an Insecure value may indicate that a window that previously owned a port may spoof messages for a certain period of time between when an export occurs and when the port is verified from its new destination. An Integrity value may indicate whether a message was not tampered with during transmission. A Privacy value may protect message content from being revealed to unauthorized individuals or systems by nodes in a network that transfer the message.

Another example field may be a key identification field which may be used to identify a port. A key identification field may identify a key, and its value may be a truncated hash of a key. Another example field associated with a public message may be a protected message field. This field may include an internal message.

Yet another example field may be a forwarded origins field. Situations may arise when a port is exported and, before the export process is complete, a window may need to forward one or more messages to one or more final destinations. In these situations, the origin of the messages may not be correct. A list of forwarded origins may be maintained. In an embodiment, the list may only be trusted if the entire chain of origins is trusted by a recipient.

In an embodiment, a protected message may be extracted according to the transport mode field and/or the key identification field. Once extracted, the message may include a private message structure within it. This structure may include a sequence number. A sequence number may help protect against replay attacks and may make encryption of messages non-deterministic. A private message structure may include an indication of message type. In an embodiment, a data message, a control message and/or an export message may be used to export ports.

A private message structure may include a data packet and/or an indication of one or more ports. An export message may include a window path and the new origin of a port.

In an embodiment, a polyfill may encrypt a payload. For example, a polyfill may encrypt a payload in port communication situations when the two sides of a message can't obtain a reference to each other's window. A string representation of the message length may be prefixed to the message together with a separator, and may be stored as, for example, encodedMessage. A keyed-hash message authentication code (HMAC) may be applied to the encodeMessage with the port key. The encodedMessage may be encrypted in AES CBC mode with the port key, using the HMAC as its initialization vector.

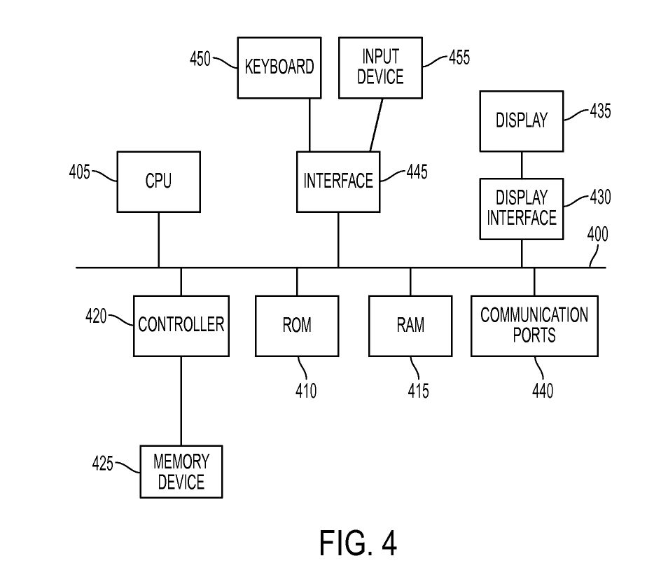

FIG. 4 depicts a block diagram of hardware that may be used to contain or implement program instructions. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an example of a production device, computing device of processor as such terms are used within this disclosure. Read only memory (ROM) 410 and random access memory (RAM) 415 constitute examples of non-transitory computer-readable storage media.

A controller 420 interfaces with one or more optional non-transitory computer-readable storage media 425 to the system bus 400. These storage media 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible non-transitory computer-readable medium such as a compact disk, a digital disk, flash memory, a memory card, a USB drive, an optical disc storage medium and/or other recording medium.

An optional display interface 430 may permit information from the bus 400 to be displayed on the display 435 in audio, visual, graphic or alphanumeric format. Communication with external devices, such as a printing device, may occur using various communication ports 440. A communication port 440 may be attached to a communication network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

1. A method of establishing a communication channel between browser applications, the method comprising:
registering one or more peers of a client network, wherein the client network comprises a plurality of browser applications that each are associated with one or more of the peers, by:
generating a registration message comprising one or more initialization instructions, and
sending the registration message to one or more of the peers, wherein each peer is a script unit associated with one or more web-based services;
generating, by a client of the client network, a discovery request that comprises a name of a requested service and instantiation information;
for each of the plurality of the peers, sending the discovery request to a two-way asynchronous port of the peer via a communication channel that enables intra-window and inter-window communication;
receiving a response from one or more of the plurality of the peers, wherein each response comprises an indication of a port associated with the peer that will serve as a reference to the requested service; and
accepting, by the client network, one of the received responses.

2. The method of claim 1, wherein sending the discovery request to a plurality of the peers comprises:
using an access control list to identify one or more of the peers that are allowed to provide the requested service; and
sending the discovery request to the identified plurality of peers.

3. The method of claim 1, further comprising:
receiving, by one or more of the peers, the discovery request; and
determining whether to respond to the discovery request using an access control list, wherein the access control list specifies whether the peer is allowed to provide the requested services and, if so, which port of the peer can provide the requested service.

4. The method of claim 1, wherein generating a discovery request comprises generating a discovery request that includes the name of the requested service as a uniform resource identifier.

5. The method of claim 1, wherein the instantiation information comprises information needed to instantiate the requested service.

6. The method of claim 1, further comprising invoking the requested service via the peer associated with the accepted response.

7. (canceled)

8. The method of claim 1, wherein the communication channel comprises-a MessageChannel object.

9. A system for establishing a communication channel between browser applications, the system comprising:
a computing device configured to operate a plurality of browser applications, wherein each browser application is associated with one or more peers; and
a computer-readable storage medium in communication with the computing device, wherein the computer-readable storage medium comprises one or more programming instructions that, when executed, cause the computing device to:
register one or more of the peers by:
generating a registration message comprising one or more initialization instructions, and
sending the registration message to one or more of the peers, wherein each peer is a script unit associated with one or more web-based services,
generate a discovery request that comprises a name of a requested service and instantiation information,
for each of the plurality of the peers, send the discovery request to a two-way asynchronous port of the peer via a communication channel that enables intra-window and inter-window communication,
receive a response from one or more of the plurality of the peers, wherein each response comprises an indication of a port associated with the peer that will serve as a reference to the requested service, and
accept one of the received responses.

10. The system of claim 9, wherein the one or more programming instructions that, when executed, cause the computing device to send the discovery request to a plurality of the peers comprise one or more programming instructions that, when executed, cause the computing device to:
use an access control list to identify one or more of the peers that are allowed to provide the requested service; and
send the discovery request to the identified plurality of peers.

11. The system of claim 9, wherein the one or more programming instructions that, when executed, cause the computing device to generate a discovery request comprise one or more programming instructions that, when executed, cause the computing device to generate a discovery request that includes the name of the requested service as a uniform resource identifier.

12. The system of claim 9, wherein the instantiation information comprises information needed to instantiate the requested service.

13. The system of claim 9, wherein the computer-readable storage medium further comprises one or more programming instructions that, when executed, cause the computing device to invoke the requested service via the peer associated with the accepted response.

14. (canceled)

15. The system of claim 9, wherein the communication channel comprises a MessageChannel object.

16. The method of claim 1, wherein the instantiation information comprises:
a scope of the requested service; and
an action to be performed by the requested service.

17. The method of claim 8, wherein the MessageChannel object comprises one or more of the following protocols:
a remote procedure call protocol; or
a transport layer polyfill.

18. The system of claim 15, wherein the MessageChannel object comprises one or more of the following protocols:
a remote procedure call protocol; or
a transport layer polyfill.
